(19) United States
(12) Patent Application Publication
(10) Pub. No.: US 2010/0070487 A1
(43) Pub. Date: Mar. 18, 2010

(54) Real Estate Locator with Real-Time Updated Result Indicator

(76) Inventor: Andrew F. Fetsch, San Jose, CA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 12/209,718

(22) Filed: Sep. 12, 2008

(51) Int. Cl. G06F 7/06; G06F 17/30

(52) U.S. Cl. 707/722; 707/E17.014

(57) ABSTRACT

A computerized method of selecting and displaying listing information relating to real estate property, which establishes a searchable database of information pertaining to real property listings, provides an interface for a user to select and enter search criteria, displays a total number of listings meeting the search criteria as the user makes and changes search criteria selections, executes a search according to the search criteria, and allows the user to display some of the listings meeting the search criteria.

### FIELD OF THE INVENTION

This invention relates to a computer implemented data search system and method using a user-interactive input that is particularly useful for searching out real estate properties, such as rental properties, matching criteria selected by the user, with a real-time count of matches displayed as the search criteria may be modified by the user.

### BACKGROUND OF THE INVENTION

In a broad sense, the present invention is a tool for enabling a user to search a database of information using preferably a plurality of criteria to find information that matches the criteria. Such search tools are of course very common. But they are not known to exist with regard to providing specific search criteria for a particular geographic and demographic audience. For instance, a person may be interested in locating a rental property within a certain distance from a point of interest, such as a university setting that matches unique criteria that are of interest to university area renters.

### SUMMARY OF THE INVENTION

The present invention finds its genesis in such a search tool for rental properties, but it could of course find broader application to real property in general. It provides the user with access to a database of information related to the rental properties that are listed (i.e., in the database), with a plurality of different search criteria available for the user to craft the desired search.

A particularly unique aspect of the invention, however, is a numeric indication of matches simultaneously being displayed with the search. The latter match-display is very useful for the user, as search criteria may be modified, so as to give the user a quick indication of how the changed search criterion is influencing the number of matches found.

What is disclosed in one embodiment of the invention is a computerized method of selecting and displaying listing information relating to real estate property. Accordingly, there is database established containing searchable information pertaining to a plurality of real property listings. An interface is provided for a user to select and otherwise enter search criteria, such as a graphic user interface. The user executes a search according to search criteria. Those criteria can be in the form of predetermined criteria, such as may simply be “checked” by a mouse click or the like, selected from a dropdown window, or an input crafted by the user (e.g., a search term), just to name a few types of criteria entry formats.

With the initial presentation of the search criteria selection user interface, there is a display of a numerical total of the number of listings available to be searched. The user then has the ability to modify the search, and in doing so, the numeric total display of matches may be changed accordingly. The user thus has the ability to immediately ascertain how the change in a criterion affects the number of matches.

The user can then display at least some of said listing meeting the search criteria.

In a particular embodiment, the GUI utilizes a geographical map. One of said search criteria is a user-sizable area-of-interest, such as a rectangle, circle or other boundary-defining visual representation. As the user changes the size or shape of the area, the numerical total changes in real-time to reflect listings encompassed therein.

Search criteria may also include location relative to a selected point, rental fee, room(s), bathrooms and utilities, just to name a few. Again, the numerical total is changeable in real-time as a search criterion may be changed by the user.

These and other advantages and objectives of the invention will be further understood upon consideration of the following detailed description of an embodiment of the invention, taken in conjunction with the following drawings, in which:

### BRIEF DESCRIPTION OF THE DRAWINGS

FIG. 1 is an illustration of a simplified user interface screen showing how several types of user input might be made available, with a real-time search result indicator of the current invention;

FIG. 2 is a flow-chart of how a search could be performed and displayed, according to an embodiment of the present invention;

FIG. 3 is an illustration of a more expansive user interface screen showing how a greater plurality of user inputs might be made available, with a real-time search result indicator of the current invention;

FIG. 4 is an illustrative geographic map having a visualizable area for defining the search territory, which area is sizable by the user; and

FIG. 5 is an illustration of the display of search results.

### DETAILED DESCRIPTION OF AN EMBODIMENT

As noted above, the present invention found its genesis, and its presently most preferred application, as a search tool for locating real properties, and in particular, rental properties. The field of use of this invention may be much broader.

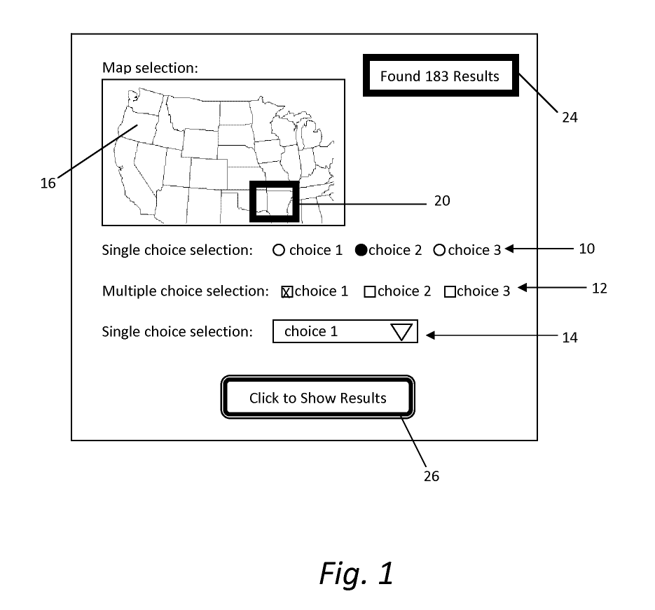

Turning now to the drawings, FIG. 1 is a very simplified illustration of the basic elements of an embodiment of the invention useful for locating real property matching certain criteria, such as a rental property. A GUI screen provides informational search criteria in the form of a single choice from several as shown in selection line 10. Choices may also be combined in a multiple choice selection line 12. Search criteria may also be provided in the form of a dropdown window 14.

There is also a map display, shown here as a map of part of the United States. The map has a user-definable area designator 20, shown here as a search box, superimposed thereon. This area designator 20 defines the territorial bounds of the search. One method for creating this area designator can be accomplished using the Google Maps API, made by Google Inc., to provide basic mapping functions and then combining it with custom JavaScript programming to overlay a selection box. That programming is well within the skill of the art, and detail thereof is accordingly omitted herein, as such is well understood. A user can change the area of the search box 20 to be more inclusive or less inclusive of territory.

The GUI further includes a real-time numerical display 24 of the number of matches to the search criteria then being input. For example, as the multiple choice line 12 is modified from the “choice 1” shown selected to include another choice in that line (say, “choice 3” in addition), the number of matching results in display 24 will thereby change. Likewise, as the search box 20 may be made smaller by the user, the matching results in display 24 may thereby change. The search may be executed simply by the entry/change of a new search criterion, or could be done by a separate search command after choices have been made.

When the user desires to see the results of the completed search, a display results command is executed, indicated by the “Show Results” mouse-click button 26.

A means to that end which can be used for purposes of generating the real-time search display is by querying a Microsoft SQL Server database, made by Microsoft Corporation using a server-side web application developed with ASP.Net, also made by Microsoft Corporation, and client-side scripting using AJAX (Asynchronous JavaScript and XML) techniques. The GUI can be generated by interfacing with the database of information and then evaluating the database for matching criteria using a ASP.Net web application to generate HTML (HyperText Markup Language), defined by the W3C (World Wide Web Consortium).

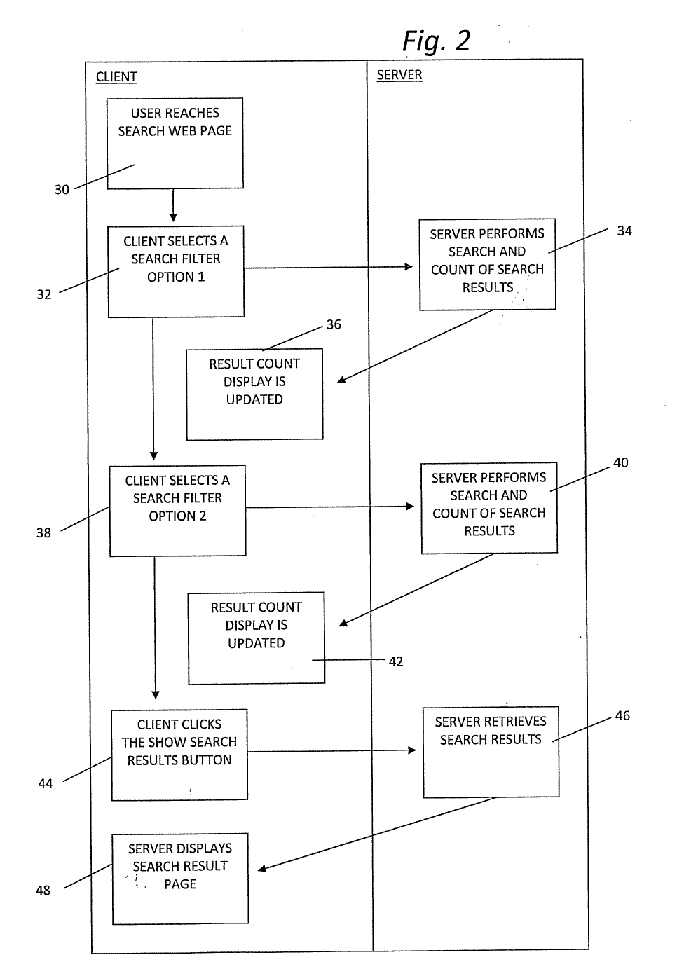

A simplified flow diagram of how the foregoing search and display program is executed in shown in FIG. 2. As shown in step 30, the user accesses the GUI by a web page address. The user (or client) then makes a selection of a search criterion in step 32, such as a single choice selection of line 10 (FIG. 1). The database of information is then searched for matches to the criterion in step 34, with a count resulting from the number of matches found. The result count is then displayed in step 36 (being shown in window display 24).

The user then can in step 38 modify the search by, for instance, entering another search parameter, such as one or more selections from the multiple choice line 12 (FIG. 1). The modified search is then executed at step 40, with the number of matches being updated, and the number thereof then being updated and displayed in step 42.

The user may then choose to peruse the results of the search at this time, by clicking on the button 24, as shown in step 44, whereupon the search results are retrieved in step 46, and some or all (depending on format and number found) of the results retrieved are displayed for the user to see in step 48.

It will be understood, of course, that the foregoing very simplified procedure is merely illustrative. Search criteria may be varied and multitudinous, and what criteria are entered when is entirely a matter of design as well as user choice.

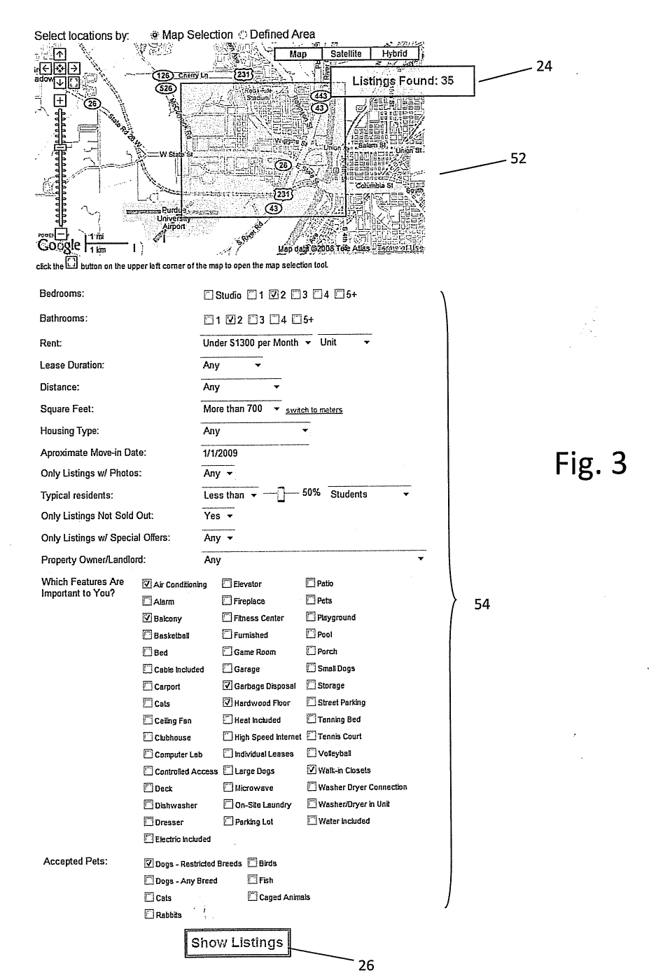

Turning to FIG. 3, another more elaborate GUI search screen is depicted. Here, the user has a choice of various areas to search, which will be coordinated with a map 52. The user can select various defined territories on the map 52, for example. Upon initial presentation of this search selection user interface, the real-time search results found window 24 will give an initial general indication of properties available.

The user has a wide number of criteria relating to the type of property sought, indicated at 54. These can be of the single choice variety (see the bedroom and bathrooms lines, for instance), or multiple choice (see the “features” selections), or dropdown variety (see “price” for instance).

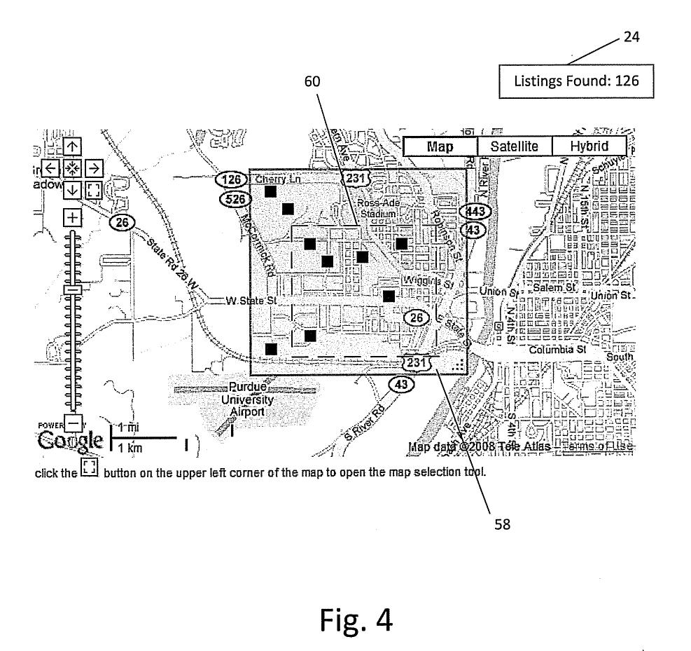

The map may alternately be as shown in FIG. 4. This map illustrates how a first search area has been defined within the square 58. That search territory yields X results, as would be shown within the window 24. By then changing the area to a smaller rectangle 60, shown in dotted line, the window 24 would then be updated to indicate that fewer matches are now found therein (the black dots visually indicating the location of the matches on the map).

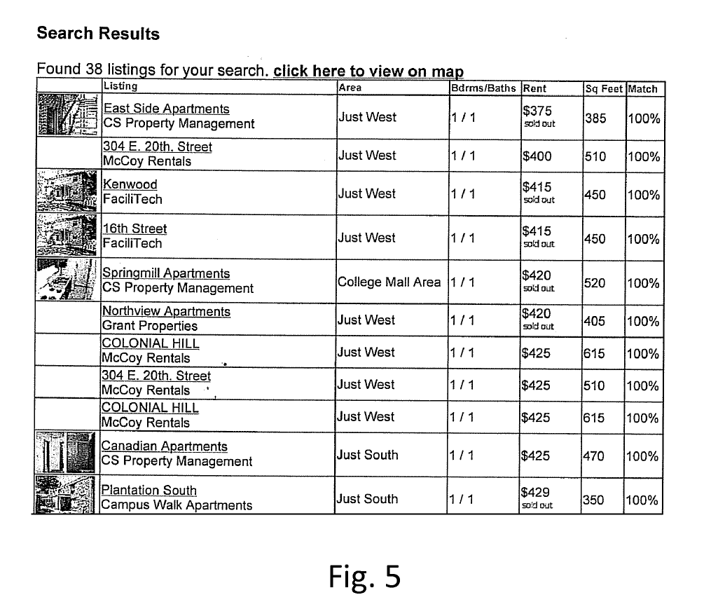

FIG. 5 is an illustration of what a Search Results screen could look like, once the user clicks on the “Show Results” button.

Thus, while the invention has been described with respect to certain embodiments, those of skill in the art will recognize changes and modifications that still will fall within the scope of the invention. It is intended that all matter contained in the above description or shown in the drawings be interpreted as illustrative, and not in a limiting sense.

What is claimed is:

1. A computerized method of selecting and displaying listing information relating to real estate property, comprising the steps of:
establishing a searchable database of information pertaining to a plurality of real property listings;
providing an interface for a user to select and otherwise enter search criteria;
displaying a numerical total of the number of listings meeting said search criteria as the user makes and changes search criteria selections;
executing a search according to said search criteria; and
allowing the user to display at least some of said listings meeting said search criteria.

2. The method of claim 1 wherein said interface includes a geographical map, one of said search criteria being a user-sizable area-of-interest, said numerical total changing in real-time to reflect listings encompassed therein as said area is changed by said user subsequent to execution of said initial search.

3. The method of claim 1 wherein said property listings are rental properties.

4. The method of claim 3 wherein said search criteria include location relative to a selected point, rental fee, room(s), bathrooms and utilities, and wherein said numerical total is changeable in real-time as a search criterion may be changed by the user.
